(19) United States
(12) Patent Application Publication
(10) Pub. No.: US 2023/0265937 A1
(43) Pub. Date: Aug. 24, 2023

(54) SOLENOID DRIVEN ACTUATOR SYSTEMS

(71) Applicant: Hamilton Sundstrand Corporation, Charlotte, NC (US)

(72) Inventors: Morgan O'Rorke, West Hartford, CT (US); Steve Doerner, Enfield, CT (US); Ryan Susca, Windsor, CT (US)

(21) Appl. No.: 17/675,591

(22) Filed: Feb. 18, 2022

(51) Int. Cl. F01D 17/12

(52) U.S. Cl. CPC F01D 17/12; F05D 2220/32; F05D 2240/12; F05D 2260/60

(57) ABSTRACT

A solenoid driven actuator system includes a first solenoid having at least one pressure input and a pressure outlet downstream from the at least one pressure input. A second solenoid has at least one pressure input and a pressure outlet downstream from the at least one pressure input. A transfer solenoid operatively coupled to the first and second solenoids. An actuator valve operatively coupled to a pressure outlet of the transfer solenoid.

### BACKGROUND OF THE INVENTION

### 1. Field of the Invention

The present disclosure relates to actuator systems and more particularly to solenoid driven actuator systems.

### 2. Description of Related Art

In many turbine engines, effector actuation systems (vanes angle, nozzle area, etc) are usually modulated, but sometimes a two-position system may be advantageous. In modern turbine engines, weight and space are more critical than previous engines because of the increased externals content added to improve engine efficiency. A traditional modulating actuator system usually has two Electro-Hydraulic Servo Valves (EHSVs) and a solenoid driven transfer valve, which tend to be heavy.

The conventional techniques have been considered satisfactory for their intended purpose. However, there is a need for improved actuator systems. This disclosure provides a solution for this need.

### SUMMARY OF THE INVENTION

A solenoid driven actuator system includes a first solenoid having at least one pressure input and a pressure outlet downstream from the at least one pressure input. A second solenoid has at least one pressure input and a pressure outlet downstream from the at least one pressure input. A transfer solenoid operatively coupled to the first and second solenoids. An actuator valve operatively coupled to a pressure outlet of the transfer solenoid.

In some embodiments, the at least one pressure input of the first solenoid includes a first pressure input and a second pressure input. The at least one pressure input of the second solenoid can include a first pressure input and a second pressure input. The transfer solenoid can be in fluid communication with the pressure outlet of the first solenoid and the pressure outlet of the second solenoid. A first pressure inlet of the transfer solenoid can be in fluid communication with the pressure outlet of the first solenoid. A second pressure inlet of the transfer solenoid can be in fluid communication with the pressure outlet of the second solenoid.

In some embodiments, depending on safety requirements of the component/program, first and second solenoids are configured and adapted to be operated on a single common channel. The first and second solenoids can be configured and adapted to be operated on separate channels. The transfer solenoid can be configured and adapted to operate on a transfer solenoid channel separate from channels controlling the first and second solenoids. The first solenoid can include a low-pressure conduit. The low-pressure conduit can include an orifice. The second solenoid can include a low-pressure conduit. The low-pressure conduit can include an orifice. The first and second solenoids each can include a low-pressure conduit and a low-pressure conduit. The low-pressure conduit of the first solenoid can include an orifice and the high-pressure conduit of the second solenoid can include an orifice.

In accordance with another aspect, a method for controlling an actuator valve with dual redundant solenoids includes providing a control signal to at least one of a first solenoid or a second solenoid to prompt an output from at least one of the first solenoid or the second solenoid, receiving the output in a transfer solenoid, providing a transfer control signal to the transfer solenoid to prompt the transfer solenoid to provide a control pressure from the output to an actuator valve via at least one of a high-pressure side or a low pressure side, and providing the control pressure from the transfer solenoid to the actuator valve.

In some embodiments, the method can include controlling actuator valve with an output of the transfer solenoid by exposing an actuator control cavity of the actuator valve to the high pressure source. The method can include controlling the actuator valve with an output of the transfer solenoid by exposing an actuator control cavity of the actuator valve to the low-pressure source.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic depiction of a solenoid driven actuator system constructed in accordance with an embodiment of the present disclosure, showing the first solenoid in control;

FIG. 2 is a schematic depiction of the system of FIG. 1, showing the second solenoid in control; and

FIG. 3 is a schematic depiction of a solenoid driven actuator system constructed in accordance with another embodiment of the present disclosure, showing the first and second solenoids driven off the same channel.

### DETAILED DESCRIPTION OF THE PREFERRED EMBODIMENTS

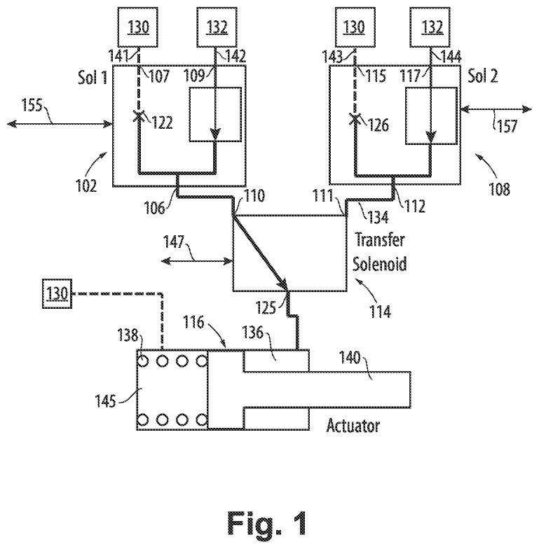

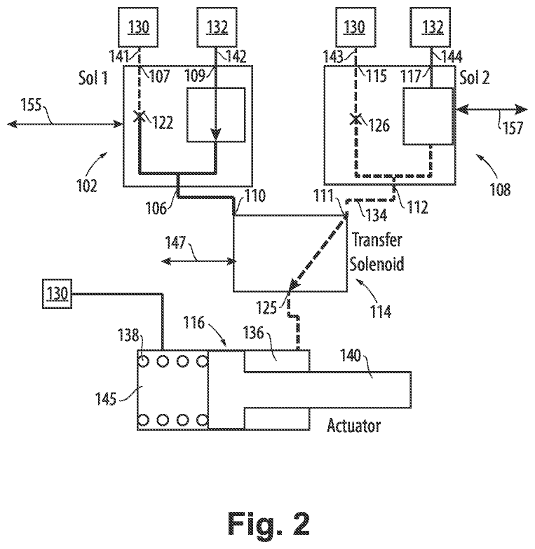

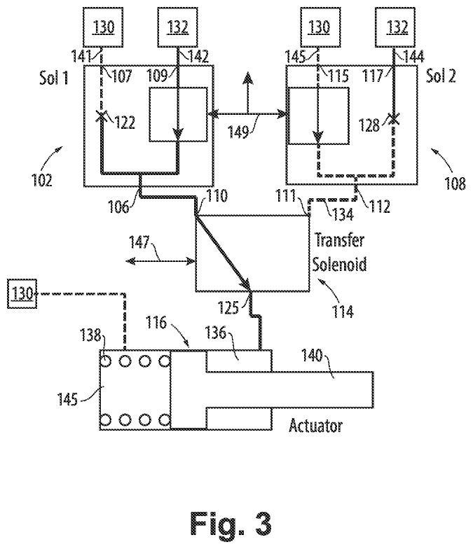

Reference will now be made to the drawings wherein like reference numerals identify similar structural features or aspects of the subject disclosure. For purposes of explanation and illustration, and not limitation, a schematic view of an exemplary embodiment of the solenoid driven actuator system in accordance with the disclosure is shown in FIG. 1 and is designated generally by reference character 100. Other embodiments of the solenoid driven actuator systems in accordance with the disclosure, or aspects thereof, are provided in FIGS. 2-3 as will be described. The systems and methods described herein can be used to provide a two-position actuator that is lighter weight and smaller in size than traditional modulating actuator systems.

As shown in FIG. 1, a solenoid driven actuator system 100 is a dual-redundant actuator system 100 that includes a first solenoid 102 (Sol 1) and a second solenoid 108 (Sol 2). The system 100 includes a transfer solenoid 114 operatively coupled to the first and second solenoids 102 and 108, respectively. System 100 is arranged such that either the first solenoid 102 or the second solenoid 108 can control the output to a transfer solenoid 114. The first solenoid 102 includes a first pressure input 107 and a second pressure input 109 and a pressure outlet 106 downstream from pressure inputs 107 and 109. The second solenoid 108 includes a first pressure input 115 and a second pressure input 117 and a second pressure outlet 112 downstream from first and second pressure inputs 115 and 117, respectively. The first pressure input 107 of the first solenoid 102 is in fluid communication with a low-pressure source 130.

With continued reference to FIG. 1, the first pressure input 115 of the second solenoid 108 is in fluid communication with a low-pressure source 130. The second pressure input 117 of the second solenoid 108 is in fluid communication with a high-pressure source 132. The second pressure input 109 of the first solenoid 102 is in fluid communication with a high-pressure source 132. The dual-redundant actuator is composed using two 2-way solenoids (102 and 108) and a 3-way transfer solenoid 114 to give control to either first or second solenoid 102 and 108.

With continued reference to FIG. 1, the first and second solenoids 102 and 108, respectively, are configured and adapted to be operated on separate channels 155 and 157, respectively. The channels can be operatively coupled to at least one FADEC (Full Authority Digital Engine Control) to receive commands therefrom. The transfer solenoid 114 is configured and adapted to operated on a transfer solenoid channel 147 separate from channels 155 and 157 controlling the first and second solenoids 102 and 108. As such, all three solenoids (first 102, second 108 and transfer 114) are controlled by independent channels (first channel 155, second channel 157 and transfer channel 147, respectively). Channels 155, 157 and 147 are schematically depicted as double-headed arrows. The discrete nature of channels 155 and 157, and transfer channel 147, provides redundant control in case of controller channel failure of a solenoid. An actuator valve 116 is operatively coupled to a pressure outlet 125 of the transfer solenoid 114. Actuator valve 116 includes a spring cavity 145 that is in fluid communication with low-pressure source 130, which can be the same as or different from the low pressure sources 130 coupled to the first and second solenoids 102 and 108. The first solenoid 102 includes a low-pressure conduit 141, shown schematically with broken lines to indicate low-pressure. The second solenoid 108 includes a low-pressure conduit 143. The low-pressure conduit 143 includes an orifice 126. Channels 155, 157 and 147 can be made from a variety of data transmission devices, wireless, wired, or otherwise.

In FIG. 1, the transfer solenoid 114 is in fluid communication with the pressure outlet 106 of the first solenoid 102. A first pressure inlet 110 of the transfer solenoid 114 is in fluid communication with the pressure outlet 106 of the first solenoid 102. A second pressure inlet 111 of the transfer solenoid 114 is in fluid communication with the pressure outlet 112 of the second solenoid 108. The first solenoid 102 includes a high-pressure conduit 142, shown in solid lines to indicate high-pressure. The second solenoid 108 includes a high-pressure conduit 144. The low-pressure conduit 141 of the first solenoid 102 includes an orifice 122 and the low-pressure conduit 143 of the second solenoid 108 includes an orifice 126. The high pressure from high-pressure conduit 142 goes into a portion of low-pressure conduit 141 downstream from the orifice 122, which is shown in a solid line to schematically indicate high-pressure relative to the low-pressure upstream from orifice 122. The high pressure from high-pressure conduit 144 goes into a portion of low-pressure conduit 143 downstream from the orifice 126, which is shown in a solid line to schematically indicate high-pressure relative to the low-pressure upstream from orifice 126.

As shown in FIG. 1, both the first and second solenoids 102 and 108, respectively, are shown switched to high-pressure, and the first solenoid 102 is shown in control. The first and second pressure inlets 110 and 111, respectively, of the transfer solenoid 114 direct the output from the first solenoid 102 to actuator valve 116 (shown retracting actuator). Those skilled in the art will readily appreciate that in some embodiments, the actuator valve 116 may be arranged differently (e.g., spring 138 may positioned within the actuator control cavity 136) or may be a two-position valve.

With reference now to FIG. 2, the first solenoid 102 is switched to high-pressure, the second solenoid 108 is switched to low-pressure, and second solenoid 108 is shown in control. The low-pressure conduit 141 of the first solenoid 102 includes an orifice 122. The high pressure from high-pressure conduit 142 goes into a portion of low-pressure conduit 141 downstream from the orifice 122, which is shown in a solid line to schematically indicate high-pressure relative to the low-pressure upstream from orifice 122. FIG. 2 is the same as FIG. 3 except that transfer solenoid 114 directs the low-pressure output from the second solenoid 108 to actuator valve 116 (the second solenoid is shown extending actuator body 140) instead of from the first solenoid 102 to the actuator valve 116. The pressure in actuator control cavity 136 controls whether spring 138 is compressed or released by controlling the axial position of an actuator body 140. The pressure in actuator control cavity 136 controls whether spring 138 is compressed or released by controlling the axial position of an actuator body 140.

With reference now to FIG. 3, system 100 of FIG. 3 is the same as system 100 in FIGS. 1 and 2, except that the first and second solenoids 102 and 108 are shown as being operated on a common channel 149. In this way, first and second solenoids 102 and 108 are controlled with a single FADEC channel, and the transfer solenoid 114 is controlled with its own transfer channel 147. The channels, whether a single channel or two independent channels, can be operatively coupled to at least one FADEC for receiving controls therefrom. As shown in FIG. 3, if channel 149 fails, then transfer channel 147 still communicates with transfer solenoid 114 to provide the control. This provides redundant control in the event of controller channel failure.

As shown in FIG. 3, the first solenoid 102 is shown switched to high-pressure and the second solenoid 108 is shown switched to low-pressure. The first solenoid 102 includes a high-pressure conduit 142, shown in solid lines to indicate high-pressure. The second solenoid 108 includes a high-pressure conduit 144. The low-pressure conduit 141 of the first solenoid 102 includes an orifice 122 and the high-pressure conduit 144 of the second solenoid 108 includes an orifice 128. The high pressure from high-pressure conduit 142 goes into a portion of low-pressure conduit 141 downstream from the orifice 122, which is shown in a solid line to schematically indicate high-pressure relative to the low-pressure upstream from orifice 122.

As solenoids 102 and 108 are smaller and lighter than EHSVs system 100 provides reduced weight and reduced size envelope as compared with traditional EHSVs. Moreover, if the effector system that the actuator body 140 controls does not have its own means of tracking performance (position sensor, pressure sensor, temp sensor, etc) embodiments of system 100 can use proximity probes (which have good resolution to determine position in a non-modulated actuator) to determine the left or right position of the actuator body 140. Proximity probes are magnetic sensors that can be installed in the actuator valve 116 to determine position of actuator body 140 (e.g., is the actuator body in the left or right position). Proximity probes are lighter than a linear variable differential transformer (LVDT), which would typically be used to detect the position of the actuator in an EHSV system. The ability to use these proximity probes results in further potential weight and size reduction as compared with traditional EHSV systems. Additionally, because solenoids 102 and 108 have little to no internal leakage, system 100 also provides for improved fuel system efficiency and reliability as compared with EHSVs. The simplified control nature of solenoids, e.g., the simple I/O control structure, provides easier control as compared with EHSVs. As such, in situations where a non-modulated effector is appropriate, system 100 offers considerable benefits over traditional EHSVs.

A method for controlling an actuator valve, e.g. actuator valve 116, with dual redundant solenoids, e.g. first and second solenoids 102 and 108, includes providing a control signal to at least one of a first solenoid or a second solenoid to prompt an output from at least one of the first solenoid or the second solenoid. The method includes receiving the output in a transfer solenoid, e.g. transfer solenoid 114, and providing a transfer control signal to the transfer solenoid to prompt the transfer solenoid to provide a control pressure from the output to the actuator valve via a high-pressure side, e.g. inlet 110, and/or a low pressure side, e.g. inlet 111.

The method includes providing the control pressure from the transfer solenoid to the actuator valve. The method includes controlling the actuator valve with an output of the transfer solenoid by exposing an actuator control cavity, e.g. actuator control cavity 136, of the actuator valve to the high pressure source. In some embodiments, the method includes controlling the actuator valve with an output of the transfer solenoid by exposing the actuator cavity of the actuator valve to the low pressure source. The method includes communicating commands to the transfer solenoid through a transfer channel, e.g. channel 147. The method includes communicating commands to the first solenoid through a first channel, e.g. channel 155, and communicating commands to the second solenoid through a second channel, e.g. channel 157, where the first and second channels are separate from one another. The transfer channel is separate from both first and second channels. In some embodiments, the method can include communicating commands to the first and second solenoids through a common channel, e.g. common channel 149. In this instance, transfer channel is still separate from common channel 149.

The methods and systems of the present disclosure, as described above and shown in the drawings, provide for solenoid driven actuator system, with superior properties including reduced weight and size, and increased reliability and efficiency. The systems and methods of the present invention can apply to a variety of actuators, or the like. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A solenoid driven actuator system, the system comprising:
a first solenoid having at least one pressure input and a pressure outlet downstream from the at least one pressure input;
a second solenoid having at least one pressure input and a pressure outlet downstream from the at least one pressure input;
a transfer solenoid operatively coupled to the first and second solenoids; and
an actuator valve operatively coupled to a pressure outlet of the transfer solenoid.

2. The solenoid driven actuator system of claim 1, wherein the at least one pressure input of the first solenoid includes a first pressure input and a second pressure input.

3. The solenoid driven actuator system of claim 1, wherein the at least one pressure input of the second solenoid includes a first pressure input and a second pressure input.

4. The solenoid driven actuator system of claim 1, wherein the transfer solenoid is in fluid communication with the pressure outlet of the first solenoid and the pressure outlet of the second solenoid.

5. The solenoid driven actuator system of claim 1, wherein a first pressure inlet of the transfer solenoid is in fluid communication with the pressure outlet of the first solenoid.

6. The solenoid driven actuator system of claim 1, wherein a second pressure inlet of the transfer solenoid is in fluid communication with the pressure outlet of the second solenoid.

7. The solenoid driven actuator system of claim 1, wherein the first and second solenoids are configured and adapted to be operated on a common channel.

8. The solenoid driven actuator system of claim 1, wherein the first and second solenoids are configured and adapted to be operated on separate channels.

9. The solenoid driven actuator system of claim 1, wherein the transfer solenoid is configured and adapted to operated on a transfer solenoid channel separate from channels controlling the first and second solenoids.

10. The solenoid driven actuator system of claim 1, wherein the first solenoid includes a low-pressure conduit, wherein the low-pressure conduit includes an orifice.

11. The solenoid driven actuator system of claim 1, wherein the second solenoid includes a low-pressure conduit, wherein the low-pressure conduit includes an orifice.

12. The solenoid driven actuator system of claim 1, wherein the first and second solenoids each include a high-pressure conduit and a low-pressure conduit, wherein the low-pressure conduit of the first solenoid includes an orifice and wherein the high-pressure conduit of the second solenoid includes an orifice.

13. A method for controlling an actuator with dual redundant solenoids, the method comprising:
providing a control signal to at least one of a first solenoid or a second solenoid to prompt an output from at least one of the first solenoid or the second solenoid;
receiving the output in a transfer solenoid;
providing a transfer control signal to the transfer solenoid to prompt the transfer solenoid to provide a control pressure from the output to an actuator via at least one of a high-pressure side or a low pressure side; and
providing the control pressure from the transfer solenoid to the actuator valve.

14. The method as recited in claim 13, controlling the actuator valve with an output of the transfer solenoid by exposing an actuator control cavity of the actuator valve to the high pressure source.

15. The method as recited in claim 13, controlling the actuator valve with an output of the transfer solenoid by exposing an actuator control cavity of the actuator valve to the low pressure source.
